(19) United States
(12) Patent Application Publication
(10) Pub. No.: US 2022/0032909 A1
(43) Pub. Date: Feb. 3, 2022

(54) CONTROL APPARATUS, VEHICLE, NON TRANSITORY COMPUTER READABLE MEDIUM, AND CONTROL METHOD

(71) Applicant: Toyota Jidosha Kabushiki Kaisha, Toyota-shi Aichi-ken (JP)

(72) Inventors: Roger Kyle, Nagoya-shi Aichi-ken (JP); Yuta Kodama, Toyota-shi Aichi-ken (JP); Corentin Marie C. Mossoux, Toyota-shi Aichi-ken (JP); Shunsuke Tanimori, Nagoya-shi Aichi-ken (JP); Rio Minagawa, Nagoya-shi Aichi-Ken (JP); Dany Benjamin, Rowlett, TX (US)

(21) Appl. No.: 17/390,354

(22) Filed: Jul. 30, 2021

(30) Foreign Application Priority Data
Aug. 3, 2020 (JP) 2020-132047

(51) Int. Cl. B60W 30/165; B60D 1/58

(52) U.S. Cl. CPC B60W 30/165; B60D 1/01; B60W 2420/42; B60D 1/58

(57) ABSTRACT

A control apparatus that is communicably connected to a towing vehicle, the control apparatus including a controller configured to: acquire positional information for a towing target vehicle to be towed; at a location within a predetermined distance from a location corresponding to the positional information, identify the towing target vehicle; based on a targeted relative relationship between the towing vehicle and the towing target vehicle, control the towing vehicle; and when a difference between the targeted relative relationship and an actual relative relationship is within an allowable range, operate a towing apparatus of the towing vehicle to tow the towing target vehicle.

### CROSS-REFERENCE TO RELATED APPLICATION

This application claims priority to Japanese Patent Application No. 2020-132047, filed on Aug. 3, 2020, the entire contents of which are incorporated herein by reference.

### TECHNICAL FIELD

The present disclosure relates to a control apparatus, a vehicle, a program, and a control method.

### BACKGROUND

Technology for identifying a broken-down vehicle and towing the broken-down vehicle thus identified is known (see, for example, Patent Literature [PTL] 1).

### CITATION LIST

### Patent Literature

PTL 1: JP 2019-171971 A

### SUMMARY

PTL 1 discloses technology for towing using an autonomous vehicle, which still has room for improvement in terms of safety when towing.

It would be helpful to provide a control apparatus, a vehicle, a program, and a control method that are capable of improving safety when towing.

A control apparatus according to an embodiment of the present disclosure is a control apparatus that is communicably connected to a towing vehicle, the control apparatus including a controller configured to:

acquire positional information for a towing target vehicle to be towed;

at a location within a predetermined distance from a location corresponding to the positional information, identify the towing target vehicle;

based on a targeted relative relationship between the towing vehicle and the towing target vehicle, control the towing vehicle; and

when a difference between the targeted relative relationship and an actual relative relationship is within an allowable range, operate a towing apparatus of the towing vehicle to tow the towing target vehicle.

A program according to an embodiment of the present disclosure is configured to cause a computer as a control apparatus that is communicably connected to a towing vehicle, to execute operations, the operations including:

acquiring positional information for a towing target vehicle to be towed;

at a location within a predetermined distance from a location corresponding to the positional information, identifying the towing target vehicle;

based on a targeted relative relationship between the towing vehicle and the towing target vehicle, controlling the towing vehicle; and

when a difference between the targeted relative relationship and an actual relative relationship is within an allowable range, operating a towing apparatus of the towing vehicle to tow the towing target vehicle.

A control method according to an embodiment of the present disclosure is a control method by a control apparatus that is communicably connected to a towing vehicle, the control method including:

acquiring positional information for a towing target vehicle to be towed;

at a location within a predetermined distance from a location corresponding to the positional information, identifying the towing target vehicle;

based on a targeted relative relationship between the towing vehicle and the towing target vehicle, controlling the towing vehicle; and

when a difference between the targeted relative relationship and an actual relative relationship is within an allowable range, operating a towing apparatus of the towing vehicle to tow the towing target vehicle.

A control apparatus, a vehicle, a program, and a control method according to an embodiment of the present disclosure are capable of improving safety when towing.

### BRIEF DESCRIPTION OF THE DRAWINGS

In the accompanying drawings:

FIG. 1 is a schematic diagram of an information processing system;

FIG. 2 is a block diagram illustrating a configuration of a towing target vehicle;

FIG. 3 is a block diagram illustrating a configuration of a towing vehicle;

FIG. 4 is a block diagram illustrating a configuration of a control apparatus;

FIG. 5 is a diagram illustrating a data structure for a towing target vehicle database (DB);

FIG. 6 is a diagram illustrating a captured image;

FIG. 7 is a diagram illustrating a data structure for a towing vehicle DB; and

FIG. 8 is a flowchart illustrating operations of the control apparatus.

### DETAILED DESCRIPTION

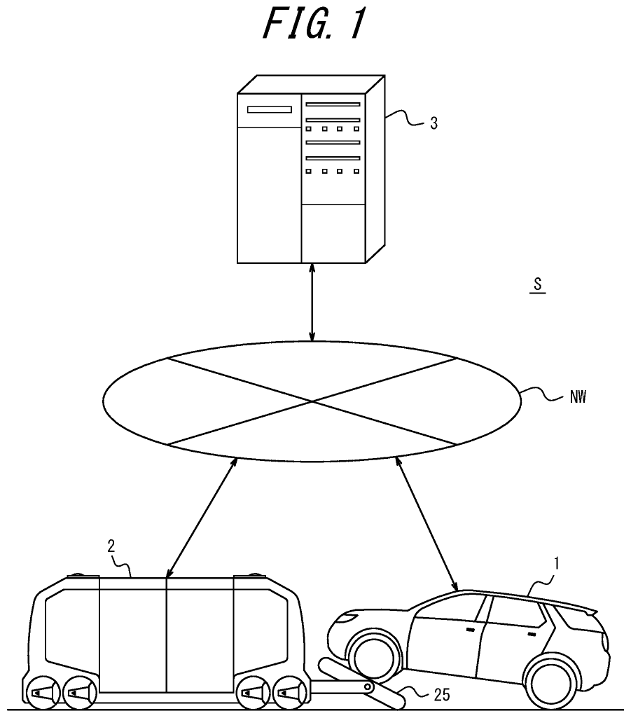

FIG. 1 is a schematic diagram of an information processing system S according to the present embodiment. The information processing system S includes a towing target vehicle 1, a towing vehicle 2, and a control apparatus 3, which are communicably connected to one another via a network NW. FIG. 1 illustrates one each of the towing target vehicle 1, the towing vehicle 2, and the control apparatus 3 for convenience of illustration. However, the number of the towing target vehicle 1, the number of the towing vehicle 2, and the number of the control apparatus 3 are not limited to one each. The network NW includes, for example, a mobile object communication network and the Internet.

An outline of processing to be executed by the control apparatus 3 according to the present embodiment will be described. The control apparatus 3 acquires positional information for the towing target vehicle 1 to be towed, and identifies the towing target vehicle 1 at a location within a predetermined distance from the location corresponding to the positional information. The control apparatus 3 controls the towing vehicle 2 based on a targeted relative relationship (e.g., distance or weight difference between vehicles) between the towing vehicle 2 and the towing target vehicle 1. The control apparatus 3 operates a towing apparatus 25 of the towing vehicle 2 to tow the towing target vehicle 1 when the difference between the targeted relative relationship and the actual relative relationship is within an allowable range. This configuration enables the control apparatus 3 to tow the towing target vehicle 1 when the difference is within the allowable range, and therefore, towing can be performed only when safety can be ensured. As a result, the control apparatus 3 can improve safety when towing. The control apparatus 3 can also tow a vehicle that is obstructing traffic, and thus can make road traffic smoother.

Examples of a vehicle for use as the towing target vehicle 1 or as the towing vehicle 2 include any type of automobile such as a gasoline vehicle, a diesel vehicle, an HV, a PHV, an EV, or an FCV. The term “HV” is an abbreviation of Hybrid Vehicle. The term “PHV” is an abbreviation of Plug-in Hybrid Vehicle. The term “EV” is an abbreviation of Electric Vehicle. The term “FCV” is an abbreviation of Fuel Cell Vehicle. The towing target vehicle 1, which is driven by a driver in the present embodiment, may be automated at any level. The level of automation is, for example, one of Level 1 to Level 5 according to the classification of the SAE. The name “SAE” is an abbreviation of the Society of Automotive Engineers. The towing target vehicle 1 and the towing vehicle 2 may be a MaaS dedicated vehicle. The term “MaaS” is an abbreviation of Mobility as a Service. The towing vehicle 2 may be stored in a parking lot, a warehouse, or inside an emergency vehicle or the like during normal times, and may be dispatched upon request from the control apparatus 3.

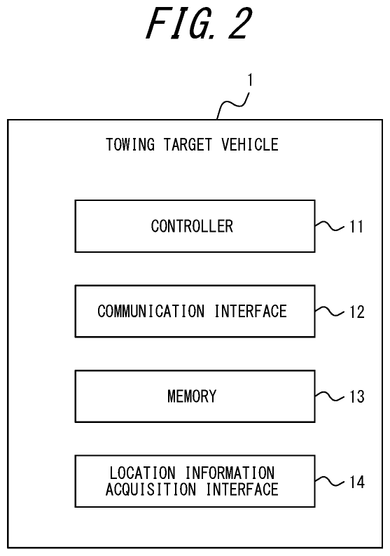

With reference to FIG. 2, an internal configuration of the towing target vehicle 1 will be described in detail.

The towing target vehicle 1 includes a controller 11, a communication interface 12, a memory 13, and a positional information acquisition interface 14. The components of the towing target vehicle 1 are communicably connected to one another via, for example, dedicated lines.

The controller 11 includes, for example, at least one general purpose processor including a Central Processing Unit (CPU) or a Micro Processing Unit (MPU). The controller 11 may include at least one dedicated processor that is dedicated to specific processing. The controller 11 may include at least one dedicated circuit instead of a processor. Examples of the dedicated circuit may include a Field-Programmable Gate Array (FPGA) and an Application Specific Integrated Circuit (ASIC).

The communication interface 12 includes at least one communication module for connecting to the network NW, the communication module being compliant with wired or wireless Local Area Network (LAN) standard. The communication interface 12 may include at least one module compliant with a mobile communication standard including the 4th Generation (4G) standard or the 5th Generation (5G) standard. The communication interface 12 may include at least one communication module or the like compliant with a short-range wireless communication standard or specification, including Bluetooth® (Bluetooth is a registered trademark in Japan, other countries, or both), AirDrop® (AirDrop is a registered trademark in Japan, other countries, or both), IrDA, ZigBee® (ZigBee is a registered trademark in Japan, other countries, or both), Felica® (Felica is a registered trademark in Japan, other countries, or both), or RFID. The communication interface 12 is configured to transmit and receive any information via the network NW. This information includes, for example, positional information acquired using the Global Positioning System (GPS).

The memory 13 is, for example, a semiconductor memory, a magnetic memory, or an optical memory, but is not limited thereto. The memory 13 may function as, for example, a main memory, an auxiliary memory, or a cache memory. The memory 13 may store information resulting from analysis or processing performed by the controller 11. The memory 13 may store various types of information or the like related to the operations or control of the towing target vehicle 1. The memory 13 may store a system program, an application program, embedded software, or the like.

An example of the positional information acquisition interface 14 includes an antenna. The positional information acquisition interface 14 acquires positional information for the towing target vehicle 1 using, for example, GPS.

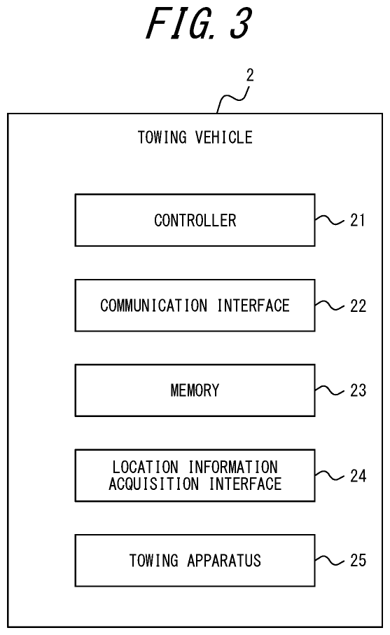

With reference to FIG. 3, an internal configuration of the towing vehicle 2 will be described in detail.

The towing vehicle 2 includes a controller 21, a communication interface 22, a memory 23, a positional information acquisition interface 24, and a towing apparatus 25. The components of the towing vehicle 2 are communicably connected to one another via, for example, dedicated lines.

In the present embodiment, the hardware configurations of the controller 21, the communication interface 22, the memory 23, and the positional information acquisition interface 24 each are the same as the hardware configurations of the controller 11, the communication interface 12, the memory 13, and the positional information acquisition interface 14 of the towing target vehicle 1. Thus, a description thereof is omitted here.

The towing apparatus 25 is an apparatus for physically or electronically towing another vehicle. For example, the towing apparatus 25 may be an apparatus for lifting the front wheels of another vehicle, as illustrated in FIG. 1. As an alternative example, the towing apparatus 25 may be a trailer or wheeled jack that carries the towing target vehicle 1 and is coupled to the towing vehicle 2. The towing apparatus 25 may be a towing hook. The towing apparatus 25 may also perform inter-vehicle communication with the towing target vehicle 1 to electronically tow the towing target vehicle 1.

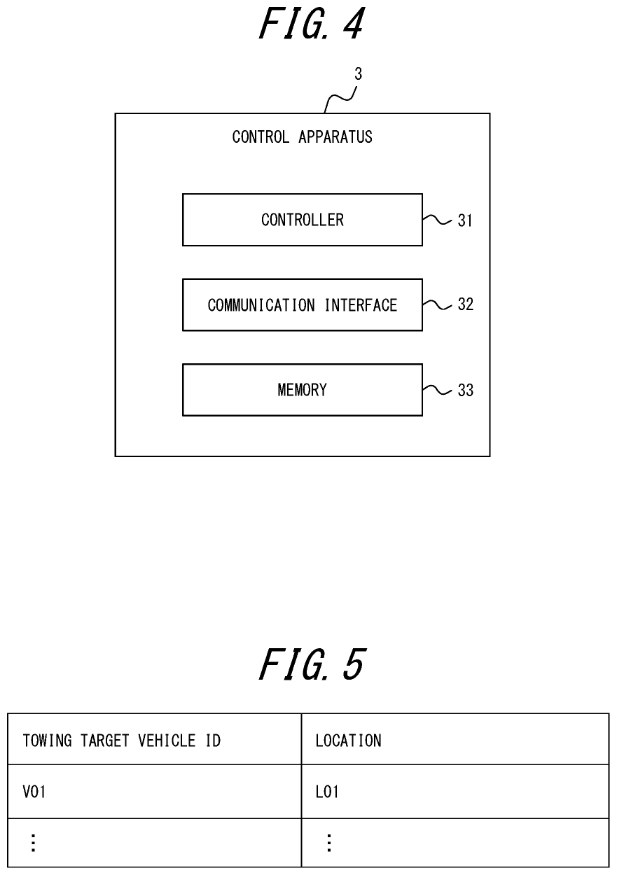

With reference to FIG. 4, an internal configuration of the control apparatus 3 will be described in detail. The control apparatus 3 may be a server that assists a provider in providing a vehicle dispatch service. The control apparatus 3 may be installed, for example, in a facility dedicated to a vehicle dispatcher or in a shared facility including a data center. As an alternative example, the control apparatus 3 may be mounted in the towing vehicle 2.

The control apparatus 3 includes a controller 31, a communication interface 32, and a memory 33. The components of the control apparatus 3 are communicably connected to one another, for example, via dedicated lines.

In the present embodiment, the hardware configurations of the controller 31, the communication interface 32, and the memory 33 of the control apparatus 3 may be the same as the hardware configurations of the controller 11, the communication interface 12, and memory 13 of the towing target vehicle 1. Thus, the description thereof is omitted here.

The memory 33 includes a towing target vehicle DB and a towing vehicle DB. In the towing target vehicle DB, the ID of the towing target vehicle 1 is stored in association with the current location of the towing target vehicle 1. In the towing vehicle DB, the ID of the towing vehicle 2 is stored in association with the current location of the towing vehicle 2. As an alternative example, the towing target vehicle DB and the towing vehicle DB may be stored in a storage device external to the control apparatus 3 and accessed by the control apparatus 3.

Hereinafter, processing to be executed in the information processing system S according to the present embodiment will be described in detail. By way of example, explained below is a situation in which the towing target vehicle 1 has developed engine trouble while the towing target vehicle 1 is driving, and the towing target vehicle 1 has stopped on a roadway. In the present embodiment, the towing target vehicle 1 is considered as being in a breakdown state when the towing target vehicle 1 suffers any one of the following exemplary conditions:
the towing target vehicle 1 is involved in an accident;
a tire or a wheel of the towing target vehicle 1 is damaged;
the battery of the towing target vehicle 1 is damaged;
the towing target vehicle 1 runs out fuel; and
the air conditioning or a light of the towing target vehicle 1 is damaged.

Upon detecting that the towing target vehicle 1 has developed trouble and has broken-down, the towing target vehicle 1 notifies the control apparatus 3 of the breakdown. The towing target vehicle 1 transmits the positional information for the towing target vehicle 1 to the control apparatus 3. As an alternative example, any vehicle other than the towing target vehicle 1 may detect that the towing target vehicle 1 has broken-down, by image analysis or the like, and notify the control apparatus 3 of the breakdown and location of the towing target vehicle 1.

Upon acquiring the positional information, the control apparatus 3 stores the position of the towing target vehicle 1 in association with the ID of the towing target vehicle 1 as illustrated in FIG. 5.

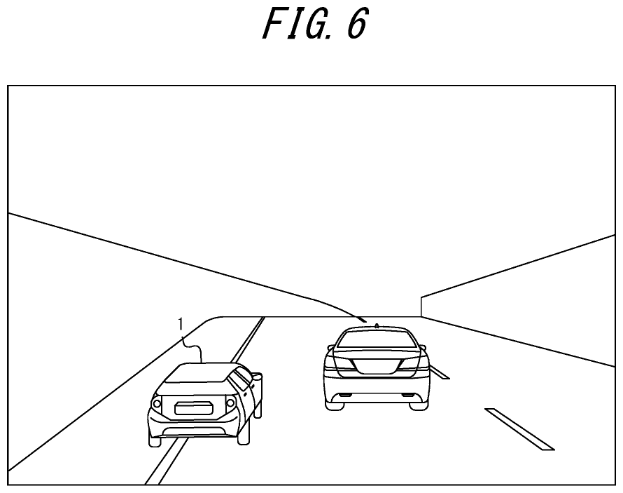

The control apparatus 3 identifies the towing target vehicle 1, at a location within a predetermined distance from the location of the towing target vehicle 1. Specifically, the control apparatus 3 causes any vehicle that is found (e.g., driving or stopped) within a predetermined distance from the location of the towing target vehicle 1, to capture an image of the towing target vehicle 1, and acquires the captured image. An example of the captured image is illustrated in FIG. 6. The control apparatus 3 analyzes the captured image to identify the towing target vehicle 1. The control apparatus 3 may analyze the captured image to determine the breakdown state of the towing target vehicle 1 (e.g., the type of the breakdown or the site of the breakdown), based on the captured image, and determine whether the towing target vehicle 1 needs to be towed, based on the breakdown state of the towing target vehicle 1. For the image analysis, any image analysis method, such as machine learning, may be used. The control apparatus 3 may notify the breakdown state of the towing target vehicle 1 thus determined to a terminal apparatus of a person in charge of repair or the like. As an alternative example, any vehicle that has captured an image of the towing target vehicle 1 may determine whether the towing target vehicle 1 needs to be towed and notify the result of determination to the control apparatus 3 or a terminal apparatus of a person in charge of repair or the like. As another alternative example, the towing target vehicle 1 itself may determine whether the towing target vehicle 1 needs to be towed, and notify the result of the determination to the control apparatus 3 or a terminal apparatus of a person in charge of repair or the like.

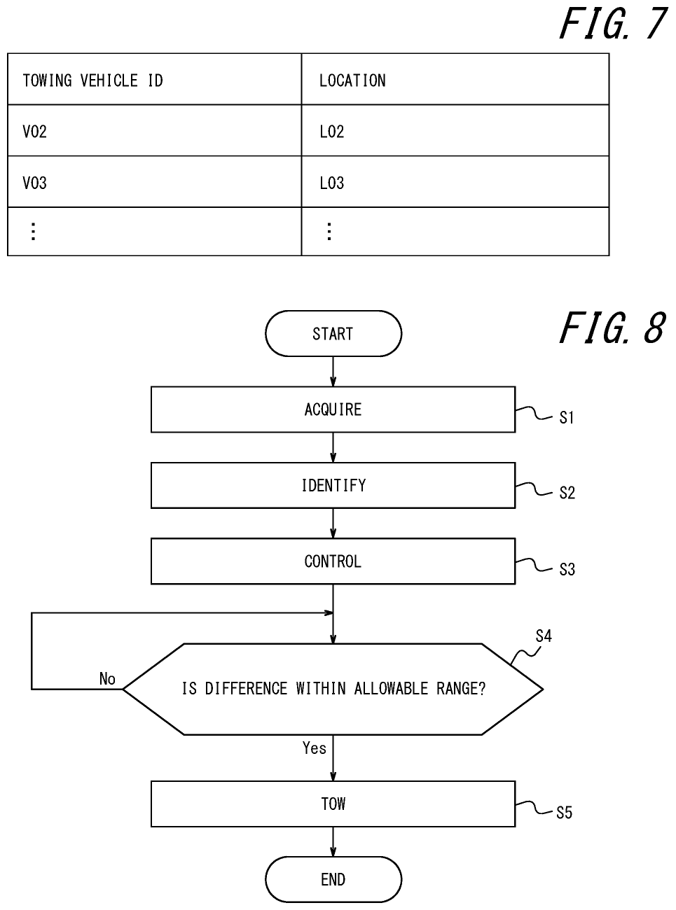

When the towing target vehicle 1 needs to be towed, the control apparatus 3 refers to the towing vehicle DB of FIG. 7 to identify a towing vehicle 2 that is found within a predetermined distance from the location of the towing target vehicle 1. Specifically, the control apparatus 3 compares the location of the towing target vehicle 1 with the location of each towing vehicle 2 to identify a towing vehicle 2 that is within a predetermined distance from the location of the towing target vehicle 1. As an additional example, the control apparatus 3 may select one of a plurality of towing vehicles, as the towing vehicle 2, depending on, for example, the breakdown state of the towing target vehicle 1 or the weight of the towing target vehicle 1.

The control apparatus 3 dispatches the identified towing vehicle 2 to a location within a predetermined distance from the towing target vehicle 1.

The control apparatus 3 determines a targeted relative relationship between the towing vehicle 2 and the towing target vehicle 1. The targeted relative relationship is a relative relationship between vehicles that is desirable for towing. Information indicating the targeted relative relationship may be stored, for example, in the memory 33 of the control apparatus 3. Examples of the targeted relative relationship may include at least one of the following conditions:
the distance between vehicles is equal to or less than 2 meters;
the difference between the weight of the towing vehicle 2 and the weight of the towing target vehicle 1 is equal to or less than a predetermined value; and
the towing target vehicle 1 is coupled to the towing vehicle 2.

The control apparatus 3 controls the towing vehicle 2 based on the targeted relative relationship between the towing vehicle 2 and the towing target vehicle 1. For example, the control apparatus 3 moves the towing vehicle 2 so that the aforementioned targeted relative relationship is satisfied.

The control apparatus 3 periodically or non-periodically determines an actual relative relationship between the towing target vehicle 1 and the towing vehicle 2. The actual relative relationship indicates a relative relationship in reality.

The control apparatus 3 periodically or non-periodically determines whether a difference between the targeted relative relationship and the actual relative relationship is within an allowable range. For example, the difference is within the allowable range when all the aforementioned conditions included in the targeted relative relationship are satisfied.

When the control apparatus 3 has determined that the difference between the targeted relative relationship and the actual relative relationship is within the allowable range, the control apparatus 3 operates the towing apparatus 25 to tow the towing target vehicle 1. Specifically, the control apparatus 3 uses the towing apparatus 25 to physically tow the towing target vehicle 1. For example, the towing vehicle 2 may tow the towing target vehicle 1 off the roadway. When the towing target vehicle 1 is heavy and the towing of the towing target vehicle 1 is difficult, the control apparatus 3 may couple at least any one vehicle other than the towing vehicle 2, directly or indirectly to the towing target vehicle 1 to tow the towing target vehicle 1.

As an alternative example, the control apparatus 3 may electronically control the towing apparatus 25 to electronically tow the towing target vehicle 1 when the towing target vehicle 1 is drivable. At this time, the towing apparatus 25 and the towing target vehicle 1 perform inter-vehicle communication. The towing target vehicle 1 follows the towing vehicle 2. When communication between the control apparatus 3 and the towing target vehicle 1 is unstable or unavailable, the control apparatus 3 may operate at least any one vehicle other than the towing target vehicle 1, as a relay vehicle, to establish a communication link between the control apparatus 3 and the towing target vehicle 1.

With reference to FIG. 8, a control method by the control apparatus 3 will be described.

In Step S1, the control apparatus 3 acquires positional information for the towing target vehicle 1.

In Step S2, the control apparatus 3 identifies a towing target vehicle 1 at a location within a predetermined distance from a location corresponding to the acquired positional information.

In Step S3, the control apparatus 3 controls the towing target vehicle 1 based on a relative relationship between a towing vehicle 2 and the towing target vehicle 1.

In Step S4, the control apparatus 3 determines whether a difference between the targeted relative relationship and the actual relative relationship is within an allowable range.

When “Yes” in Step S4, the control apparatus 3 tows the towing target vehicle 1 in Step S5.

When “No” in Step S4, the control apparatus 3 performs Step S4 again.

As described above, according to the present embodiment, a controller 31 of a control apparatus 3 acquires positional information for a towing target vehicle 1 to be towed, and at a location within a predetermined distance from a location corresponding to the positional information, identifies the towing target vehicle 1. The controller 31 controls a towing vehicle 2 based on a targeted relative relationship between the towing vehicle 2 and the towing target vehicle 1. When a difference between the targeted relative relationship and an actual relative relationship is within an allowable range, the controller 31 operates the towing apparatus 25 of the towing vehicle 2 to tow the towing target vehicle 1. This configuration enables the control apparatus 3 to tow the towing target vehicle 1 when the difference between the targeted relative relationship and the actual relative relationship is within the allowable range, and thus the towing is performed, for example, only when safety can be ensured. Thus, the control apparatus 3 can improve safety when towing. The control apparatus 3 can also make road traffic smoother.

According to the present embodiment, the towing of the towing target vehicle 1 includes electronically controlling the towing target vehicle 1 to cause the towing target vehicle 1 to follow the towing vehicle 2. When the communication between the control apparatus 3 and the towing target vehicle 1 is unstable or unavailable, the controller 31 operates a vehicle other than the towing target vehicle 1, as a relay vehicle, to establish a communication link between the control apparatus 3 and the towing target vehicle 1. This configuration enables the control apparatus 3 to reliably tow the towing target vehicle 1, to thereby make road traffic smoother.

According to the present embodiment, the towing of the towing target vehicle 1 includes controlling the towing vehicle 2 to physically tow the towing target vehicle 1. The controller 31 couples a vehicle other than the towing vehicle 2 directly or indirectly to the towing target vehicle 1, and causes the vehicle other than the towing vehicle 2 to assist the towing vehicle 2 to tow the towing target vehicle 1. This configuration enables the control apparatus 3 to reliably tow the towing target vehicle 1, to thereby make road traffic smoother.

According to the present embodiment, the identifying of the towing target vehicle 1 includes causing another vehicle, at a location within a predetermined distance from the towing target vehicle 1, to capture an image of the towing target vehicle 1, acquiring the captured image, and determining, based on the captured image, a breakdown state of the towing target vehicle 1. This configuration enables the control apparatus 3 to determine, for example, whether the towing of the target vehicle 1 is needed, so that the number of times that the towing vehicle 2 is dispatched can be brought close to the required number of times. In addition, the control apparatus 3 can notify the breakdown state to a person in charge of repair or the like, and thus the repair can be started without delay.

According to the present embodiment, the towing of the towing target vehicle 1 includes towing the towing target vehicle 1 off a roadway. This configuration enables the control apparatus 3 to quickly make road traffic smoother.

While the present disclosure has been described with reference to the drawings and examples, it should be noted that various modifications and revisions can be implemented by those skilled in the art based on the present disclosure. In addition, alterations may be made without departing from the spirit of the present disclosure. For example, functions or the like included in each step can be rearranged without logical inconsistency, and a plurality of steps can be combined into one or divided.

For example, in the aforementioned embodiment, a program that executes all or some of the functions or processing of the control apparatus 3 can be recorded on a computer readable recording medium. The computer readable recording medium includes a non-transitory computer readable medium, and may be a magnetic storage device, an optical disc, a magneto-optical recording medium, or a semiconductor memory. The program may be distributed, for example, by sale, transfer of ownership, or rental of a portable recording medium, such as a Digital Versatile Disc (DVD) or a Compact Disc Read Only Memory (CD-ROM), on which the program is recorded. The program may also be distributed by storing the program in a storage of any server and transmitting the program from any server to another computer. The program can also be realized as a program product. The present disclosure may also be realized as a program that can be executed by a processor.

1. A control apparatus that is communicably connected to a towing vehicle, the control apparatus comprising a controller configured to:
acquire positional information for a towing target vehicle to be towed;
at a location within a predetermined distance from a location corresponding to the positional information, identify the towing target vehicle;
based on a targeted relative relationship between the towing vehicle and the towing target vehicle, control the towing vehicle; and
when a difference between the targeted relative relationship and an actual relative relationship is within an allowable range, operate a towing apparatus of the towing vehicle to tow the towing target vehicle.

2. The control apparatus according to claim 1, wherein the controller is configured to tow the towing target vehicle by electronically controlling the towing target vehicle to cause the towing target vehicle to follow the towing vehicle.

3. The control apparatus according to claim 2, wherein the control apparatus is further configured to operate a vehicle other than the towing target vehicle, as a relay vehicle, to establish a communication link between the control apparatus and the towing target vehicle, when communication between the control apparatus and the towing target vehicle is unstable or unavailable.

4. The control apparatus according to claim 1, wherein the controller is configured to tow the towing target vehicle by controlling the towing vehicle to physically tow the towing target vehicle.

5. The control apparatus according to claim 4, wherein the controller is further configured to directly or indirectly couple a vehicle other than the towing vehicle to the towing target vehicle and cause the vehicle other than the towing vehicle to assist the towing vehicle to tow the towing target vehicle.

6. The control apparatus according to claim 1, wherein the controller is configured to identify the towing target vehicle by causing another vehicle, at a location within a predetermined distance from the towing target vehicle, to capture an image of the towing target vehicle, acquiring the captured image, and determining, based on the captured image, a breakdown state of the towing target vehicle.

7. The control apparatus according to claim 1, wherein the controller is configured to tow the towing target vehicle by towing the towing target vehicle off a roadway.

8. A vehicle having the control apparatus according to claim 1 mounted therein.

9. A non-transitory computer readable medium storing a program configured to cause a computer as a control apparatus that is communicably connected to a towing vehicle, to execute operations, the operations comprising:
acquiring positional information for a towing target vehicle to be towed;
at a location within a predetermined distance from a location corresponding to the positional information, identifying the towing target vehicle;
based on a targeted relative relationship between the towing vehicle and the towing target vehicle, controlling the towing vehicle; and
when a difference between the targeted relative relationship and an actual relative relationship is within an allowable range, operating a towing apparatus of the towing vehicle to tow the towing target vehicle.

10. The non-transitory computer readable medium according to claim 9, wherein the towing of the towing target vehicle includes electronically controlling the towing target vehicle to cause the towing target vehicle to follow the towing vehicle.

11. The non-transitory computer readable medium according to claim 10, wherein the operations further comprise: operating a vehicle other than the towing target vehicle, as a relay vehicle, to establish a communication link between the control apparatus and the towing target vehicle, when communication between the control apparatus and the towing target vehicle is unstable or unavailable.

12. The non-transitory computer readable medium according to claim 9, wherein towing the towing target vehicle includes controlling the towing vehicle to physically tow the towing target vehicle.

13. The non-transitory computer readable medium according to claim 12, wherein the operations further comprise: directly or indirectly coupling a vehicle other than the towing vehicle to the towing target vehicle and causing the vehicle other than the towing vehicle to assist the towing vehicle to tow the towing target vehicle.

14. The non-transitory computer readable medium according to claim 9, wherein identifying the towing target vehicle includes causing another vehicle, at a location within a predetermined distance from the towing target vehicle, to capture an image of the towing target vehicle, acquiring the captured image, and determining, based on the captured image, a breakdown state of the towing target vehicle.

15. A control method by a control apparatus that is communicably connected to a towing vehicle, the control method comprising:
acquiring positional information for a towing target vehicle to be towed;
at a location within a predetermined distance from a location corresponding to the positional information, identifying the towing target vehicle;
based on a targeted relative relationship between the towing vehicle and the towing target vehicle, controlling the towing vehicle; and
when a difference between the targeted relative relationship and an actual relative relationship is within an allowable range, operating a towing apparatus of the towing vehicle to tow the towing target vehicle.

16. The control method according to claim 15, wherein the towing of the towing target vehicle includes electronically controlling the towing target vehicle to cause the towing target vehicle to follow the towing vehicle.

17. The control method according to claim 16, further comprising: operating a vehicle other than the towing target vehicle, as a relay vehicle, to establish a communication link between the control apparatus and the towing target vehicle, when communication between the control apparatus and the towing target vehicle is unstable or unavailable.

18. The control method according to claim 15, wherein the towing of the towing target vehicle includes controlling the towing vehicle to physically tow the towing target vehicle.

19. The control method according to claim 18, further comprising: directly or indirectly coupling a vehicle other than the towing vehicle to the towing target vehicle and causing the vehicle other than the towing vehicle to assist the towing vehicle to tow the towing target vehicle.

20. The control method according to claim 15, wherein the identifying of the towing target vehicle includes causing another vehicle, at a location within a predetermined distance from the towing target vehicle, to capture an image of the towing target vehicle, acquiring the captured image, and determining, based on the captured image, a breakdown state of the towing target vehicle.
